(19) United States
(12) Patent Application Publication
(10) Pub. No.: US 2020/0066267 A1
(43) Pub. Date: Feb. 27, 2020

(54) Dialog Manager for Supporting Multi-Intent Dialogs

(71) Applicant: Nuance Communications, Inc., Burlington, MA (US)

(72) Inventors: Charles L. Ortiz, JR., Fremont, CA (US); Jiaying Shen, Burlington, MA (US)

(21) Appl. No.: 16/432,247

(22) Filed: Jun. 5, 2019

Related U.S. Application Data
(60) Provisional application No. 62/682,800, filed on Jun. 8, 2018.
(60) Provisional application No. 62/725,370, filed on Aug. 31, 2018.

(51) Int. Cl. G10L 15/22; G10L 13/04; G06F 16/9032; G10L 15/18; G06F 3/16

(52) U.S. Cl. CPC G10L 15/22; G10L 13/043; G06F 3/167; G10L 15/18; G06F 16/90332

(57) ABSTRACT

In a multi-intent search dialog, according to an embodiment of the invention, a human user and a computerized personal assistant incrementally exchange information to support achievement of multiple tasks of the human user. These multiple tasks can interact, and choices made by the user can be revised, during the course of the dialog. Those revisions can, in turn, lead to modifications in the ongoing specification of other tasks. The approach is a plan-based one in which a dialog between the two agents is viewed as a collaboration involving the tasks under discussion. Based on this approach, there is provided a computer-implemented method and a computerized collaborative dialog manager system for managing a dialog between a computerized personal assistant and a human user.

### RELATED APPLICATIONS

This application claims the benefit of U.S. Provisional Application No. 62/682,800, filed on Jun. 8, 2018, and U.S. Provisional Application No. 62/725,370, filed on Aug. 31, 2018. The entire teachings of the above applications are incorporated herein by reference.

### BACKGROUND

The study of task-based natural language dialogs has generally been restricted to settings in which two agents collaborate on a single task. Within the domain of computerized personal assistance, there is a need to be able to provide assistance to people who are engaged in multiple tasks. As an example, suppose someone is driving and wants help from his or her personal assistant regarding the choice of a movie and dinner for that evening. The problem is that these tasks can interact in both positive and negative ways: if one picks a particular movie, that choice might affect the restaurant choice, and vice versa. In addition, a user will typically not initially know what movie or restaurant he or she wants: the user may only know general constraints that the user reveals incrementally to the system during the dialog. Such systems must additionally allow users to change their mind regarding those constraints (for example, the cuisine, neighborhood or movie genre) during the course of the dialog.

The work of (Lemon et al., 2002, see References section below) focused on multitask dialogs involving the control of multiple devices. Other work has focused on a more narrow view of tasks and their interaction using a statistically-based approach (Griol and Molina, 2016) in which the term “task” has a less commonsense association. Rather than relating the term “tasks” to tasks that can effect change in the world, the focus of the reference is on, essentially, different dialog acts. Similarly, early work on agenda-based dialog management systems made use of a very loose notion of a task, and, even though the agenda-based dialog management systems addressed the need to modify previous user choices (Rudnicky and Wei, 1999), such systems did not consider revisions that should arise automatically because of consistency concerns while also conflating attributions of mental state with procedurally-motivated program elements.

Other work on multi-task dialogs has focused on dialog interruptions (Yang et al., 2011). A separate branch of research views the “multi-task dialog problem” as a problem of being able to extend an existing task dialog system with new tasks in order to increase robustness (Crook et al., 2015). Somewhat related are efforts to extend dialog systems to be able to support conversations with multiple applications (sometimes referred to as cross-domain intentions), each of which has a particular specialization (Ming Sum and Rudnicky, 2015).

There is, therefore, a need to support multiple task dialogs using a computerized personal assistant.

### SUMMARY

In a multi-intent search dialog, according to an embodiment of the invention, a human user and a computerized personal assistant incrementally exchange information to support achievement of multiple tasks of the human user. These multiple tasks can interact, and choices made by the user can be revised, during the course of the dialog. Those revisions can, in turn, lead to modifications in the ongoing specification of other tasks. The approach is a plan-based one in which a dialog between the two agents is viewed as a collaboration involving the tasks under discussion.

In accordance with an embodiment of the invention, there is provided a computer-implemented method for managing a dialog between a computerized personal assistant and a human user. The computer-implemented method comprises performing dialog processing to permit the computerized personal assistant to interact with the human user in a collaborative dialog to ascertain values of parameters to execute multiple task intentions of the human user in the same collaborative dialog, at least one of the multiple task intentions being initially partially specified. The dialog processing comprises, with a task engine of the computerized personal assistant, iteratively expanding task intentions of an intention base comprising the multiple task intentions until the computerized personal assistant and the human user collaboratively arrive at values of the parameters of the multiple task intentions of the intention base that are executable by the computerized personal assistant. The iteratively expanding task intentions of the intention base comprises, at each iteration, using the task engine of the computerized personal assistant in evaluating a new option to be expressed via an utterance of the computerized personal assistant to the human user, the new option comprising a new constraint that has not been considered before, that is consistent with the intention base, and that reduces future options for the intention base, the collaborative dialog thereby converging on the intention base being executable by the computerized personal assistant.

In further, related embodiments, evaluating the new option may be based on a currently active task intention, any constraints for the currently active task intention that have already been considered in previous iterations, and any changes in the intention base that have resulted from revisions of the intention base in previous iterations. Evaluating the new option may comprise presenting the new constraint, for the currently active task intention, to the human user, and, (i) if the human user accepts the new constraint, updating the currently active task intention with the new constraint and updating the constraint as having been considered, (ii) if the human user rejects the new constraint, updating the constraint as having been considered, (iii) if the human user proposes a new task intention that is related in parameters to an existing task intention of the intention base, sharing parameters between the new task intention and the existing task intention in the intention base, (iv) if the human user proposes a new task intention unrelated to an existing task intention, augmenting the intention base with the new task intention, and (v) if the human user adds a new constraint or changes an existing constraint, revising the intention base to include the new constraint or changed constraint and to change any other constraints in the intention base that are affected by the new constraint or changed constraint. The computer-implemented method may further comprise generating natural language to be uttered to the human user. At least two of the multiple task intentions may interact with each other by one or more of a greater cost or a lesser cost of performing the at least two of the multiple task intentions together.

In other related embodiments, the computer-implemented method may further comprise receiving, from a natural language understanding engine, a natural language interpretation of utterances of the human user to a speech recognition system. The natural language interpretation may comprise at least one of: (i) intent data and mention list data from a statistical natural language system and (ii) logical form natural language data output from a deep natural language system. The natural language interpretation may be used as the basis for at least one of a new constraint and a new task intention for the collaborative dialog between the computerized personal assistant and the human user. The computer-implemented method may further comprise modeling a task intention of the human user in a dynamic intention structure built using a library of task recipes specifying how domain tasks are to be carried out in a hierarchical task model. The dynamic intention structure may comprise, for each task intention: a task intention identifier, a task intention variable, an act, a constraint, and a representation of any subsidiary task dynamic intention structure. The computer-implemented method may further comprise modeling the at least one of the multiple task intentions, which is initially partially specified, using at least one of: (i) an existential quantifier within a scope of the initially partially specified task intention; (ii) an incompletely specified constraint of an intended action of the initially partially specified task intention; and (iii) an action description, which is not yet fully decomposed, of the initially partially specified task intention. Upon receiving an interpreted utterance of the human user that is unrelated to performing collaborative dialog to ascertain values of parameters to execute multiple task intentions of the human user, a natural language response to the human user may be generated, to guide the human user to return to the collaborative dialog.

In another embodiment according to the invention, there is provided a computerized collaborative dialog manager system for managing a dialog between a computerized personal assistant and a human user. The computerized collaborative dialog manager system comprises a processor, and a memory with computer code instructions stored thereon, the processor and the memory, with the computer code instructions, being configured to implement a task engine. The task engine is configured to perform dialog processing to permit the computerized personal assistant to interact with the human user in a collaborative dialog to ascertain values of parameters to execute multiple task intentions of the human user in the same collaborative dialog, at least one of the multiple task intentions being initially partially specified. The dialog processing comprises iteratively expanding task intentions of an intention base comprising the multiple task intentions until the computerized personal assistant and the human user collaboratively arrive at values of the parameters of the multiple task intentions of the intention base that are executable by the computerized personal assistant. The task engine comprises an option engine configured to, at each iteration, evaluate a new option to be expressed via an utterance of the computerized personal assistant to the human user. The new option comprises a new constraint that has not been considered before, that is consistent with the intention base, and that reduces future options for the intention base, the collaborative dialog thereby converging on the intention base being executable by the computerized personal assistant.

In further related embodiments, the task engine may be configured to evaluate the new option based on a currently active task intention, any constraints for the currently active task intention that have already been considered in previous iterations, and any changes in the intention base that have resulted from revisions of the intention base in previous iterations. The task engine may be configured to evaluate the new option by a computerized process comprising presenting the new constraint, for the currently active task intention, to the human user, and, (i) if the human user accepts the new constraint, updating the currently active task intention with the new constraint and updating the constraint as having been considered, (ii) if the human user rejects the new constraint, updating the constraint as having been considered, (iii) if the human user proposes a new task intention that is related in parameters to an existing task intention of the intention base, sharing parameters between the new task intention and the existing task intention in the intention base, (iv) if the human user proposes a new task intention unrelated to an existing task intention, augmenting the intention base with the new task intention, and (v) if the human user adds a new constraint or changes an existing constraint, revising the intention base to include the new constraint or changed constraint and to change any other constraints in the intention base that are affected by the new constraint or changed constraint. The computerized collaborative dialog manager system may further comprise a dialog generator configured to generate natural language to be uttered to the human user. The task engine may be configured to manage dialog in which at least two of the multiple task intentions interact with each other by one or more of a greater cost or a lesser cost of performing the at least two of the multiple task intentions together.

In other related embodiments, the computerized collaborative dialog manager system may further comprise an input processor configured to receive, from a natural language understanding engine, a natural language interpretation of utterances of the human user to a speech recognition system. The natural language interpretation may comprise at least one of: (i) intent data and mention list data from a statistical natural language system and (ii) logical form natural language data output from a deep natural language system. The task engine may be configured to use the natural language interpretation, as the basis for at least one of a new constraint and a new task intention for the collaborative dialog between the computerized personal assistant and the human user. The task engine may be configured to model a task intention of the human user in a dynamic intention structure based at least on consulting a library of task recipes specifying how domain tasks are to be carried out in a hierarchical task model. The dynamic intention structure implemented by the task engine may comprise, for each task intention: a task intention identifier, a task intention variable, an act, a constraint, and a representation of any subsidiary task dynamic intention structure. The task engine may be further configured to, upon receiving an interpreted utterance of the human user that is unrelated to performing collaborative dialog to ascertain values of parameters to execute multiple task intentions of the human user, generate a natural language response to the human user to guide the human user to return to the collaborative dialog.

In another embodiment according to the invention, there is provided a non-transitory computer-readable medium configured to store instructions for managing a dialog between a computerized personal assistant and a human user. The instructions, when loaded and executed by a processor, cause the processor to manage the dialog by performing dialog processing to permit the computerized personal assistant to interact with the human user in a collaborative dialog to ascertain values of parameters to execute multiple task intentions of the human user in the same collaborative dialog, at least one of the multiple task intentions being initially partially specified. The dialog processing comprises, with a task engine of the computerized personal assistant, iteratively expanding task intentions of an intention base comprising the multiple task intentions until the computerized personal assistant and the human user collaboratively arrive at values of the parameters of the multiple task intentions of the intention base that are executable by the computerized personal assistant. The iteratively expanding task intentions of the intention base comprises, at each iteration, using the task engine of the computerized personal assistant to evaluate a new option to be expressed via an utterance of the computerized personal assistant to the human user, the new option comprising a new constraint that has not been considered before, that is consistent with the intention base, and that reduces future options for the intention base, the collaborative dialog thereby converging on the intention base being executable by the computerized personal assistant.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic block diagram of a computerized collaborative dialog manager system for managing a dialog between a computerized personal assistant and a human user, in accordance with an embodiment of the invention.

FIG. 2 is a schematic block diagram of a task engine in a computerized collaborative dialog manager system, in accordance with an embodiment of the invention.

FIG. 3 is a schematic block diagram of a task engine interacting with an intention base in a computerized collaborative dialog manager system, in accordance with an embodiment of the invention.

FIG. 4 is a diagram illustrating a first portion of an example script of a motivating scenario for use of a computerized collaborative dialog manager system in accordance with an embodiment of the invention.

FIG. 5 is a diagram illustrating a second portion of an example script of a motivating scenario for use of a computerized collaborative dialog manager system in accordance with an embodiment of the invention.

FIG. 6 is a chart summarizing changes in context during the example scripts of FIGS. 4 and 5 for use of a computerized collaborative dialog manager system in accordance with an embodiment of the invention.

FIG. 7 is a schematic block diagram of a dynamic intention structure used in a computerized collaborative dialog manager system, in accordance with an embodiment of the invention.

FIG. 8 is an example of a procedure for an automated search dialog implemented by a computerized collaborative dialog manager system in accordance with an embodiment of the invention.

FIG. 9 is a schematic block diagram of components of a computerized personal assistant including a computerized collaborative dialog manager system in accordance with an embodiment of the invention.

FIG. 10 is a schematic diagram of a task recipe upon which a computerized collaborative dialog manager system can build a dynamic intention structure, in accordance with an embodiment of the invention.

FIG. 11 is a chart of example utterance types used with a computerized collaborative dialog manager system in accordance with an embodiment of the invention.

FIG. 12 illustrates a computer network or similar digital processing environment in which embodiments of the present invention may be implemented.

FIG. 13 is a diagram of an example internal structure of a computer (e.g., client processor/device or server computers) in the computer system of FIG. 12.

### DETAILED DESCRIPTION

A description of example embodiments follows.

Research in task-based dialog management has focused for the most part on dialogs between agents involved in a single task. A major approach within this area of research has focused on the development of plan- or collaborative-based systems where each agent shares beliefs, intentions and task information to enable completion of the task under discussion (Grosz and Sidner, 1990; Grosz and Kraus, 1996; see References section below).

In accordance with an embodiment of the invention, a computerized collaborative dialog manager system focuses instead on multiple tasks, such as planning a dinner and a movie or planning a weekend that might involve wine tasting, a balloon ride, and dinner. An embodiment implements the sorts of dialogs that one would like to support between a virtual personal assistant (VPA) and a human user who is pursuing those tasks. In such dialogs, users typically only incrementally reveal their preferences or constraints regarding an eventual choice and often shift between sub-dialogs for different tasks as the conversation unfolds. Hence, the assistant cannot pursue the solution of tasks in a linear fashion: that is, by first solving one task and then moving on to the next. Such dialogs are referred to herein as “search dialogs” because the two agents are jointly searching the space of possible options, and that space will decrease as new constraints are added, unless old ones are changed.

In accordance with an embodiment of the invention, a search dialog is roughly modeled as follows. A user and a system start with a partially specified intention, say, to reserve a table at some restaurant. As the dialog evolves, each agent exchanges information with the other in the form of constraints, options and selections. The information exchanged reflects the expertise of each agent in the collaborative planning: the user will have personal preferences for and knowledge of certain restaurants, for example, while the system will have extensive information about restaurant locations and availability. This process continues until the user and system arrive at a fully specified and executable version of the task intentions.

A number of challenges arise in such multi-task dialogs. First, the tasks under consideration can interact in both positive and negative ways. An embodiment according to the invention models a positive/negative interaction between two tasks in terms of a lesser/greater cost in doing the two tasks together. A negative interaction between, for example, the tasks of dinner at a restaurant and watching a movie at a theater later might occur through a choice of a restaurant whose location is farther from the theater than another choice. As the conversation interleaves between the individual task sub-dialogs and because of the characteristic non-linearity of task elaboration discussed above, a user's specification of a task attribute can invalidate a developing plan for the other task entailing revision of that other task description.

A second type of revision of past decisions can come about because users typically change their mind during such dialogs: initially a user might choose a particular restaurant that is Italian only to later indicate a preference for Mexican cuisine, entailing revision of some of the consequences of the previous choice (Ortiz and Shen, 2014). (In contrast to a typical master-apprentice dialog in which it is assumed that a good master does not normally make mistakes). Therefore, the dialog control that manages the moves between the subdialogs involving each task cannot be handled with a stack as is normally the case when dealing with interruptions: if the intention corresponding to the first task was put on a stack, that intention might itself be revised in the course of the conversation with a second task. Moreover, if there are more than two tasks, there is no reason to believe that after updating or revising an intention as part of the current conversation one should return to the task discussed immediately before the interruption: there may be good reasons to go back to an older task that was revised as a consequence of the change.

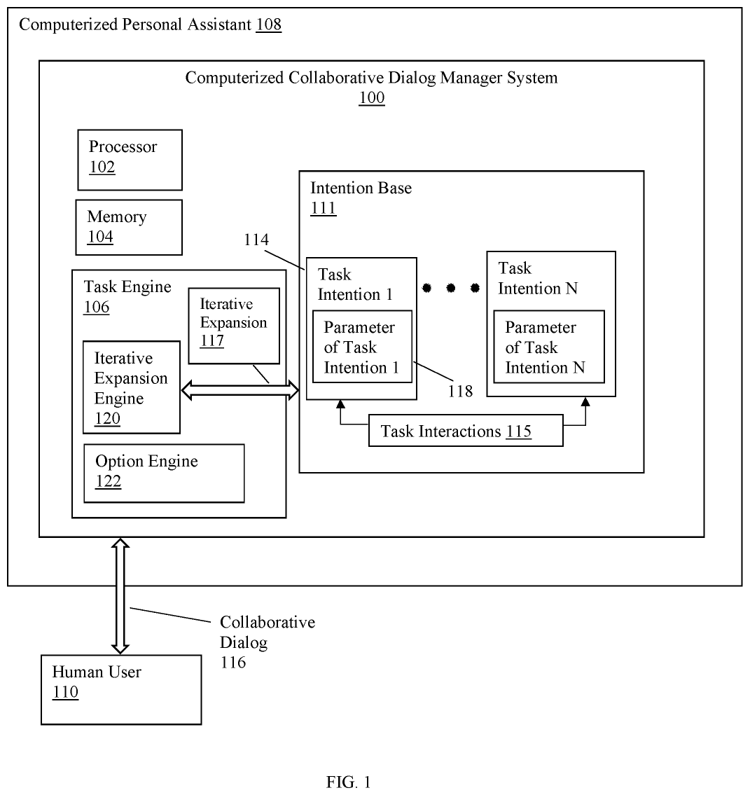

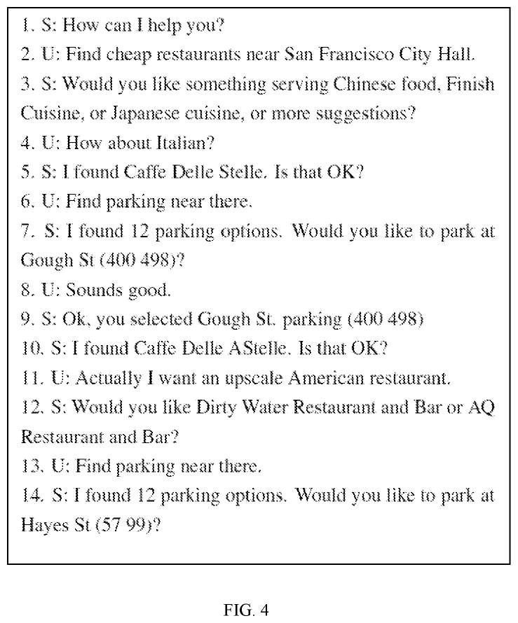

To illustrate these phenomena and the challenges involved, as well as to motivate the approach taken in accordance with an embodiment of the invention, we turn first to the examples of FIGS. 4 through 6, after which a system in accordance with an embodiment of the invention is described in reference to FIG. 1.

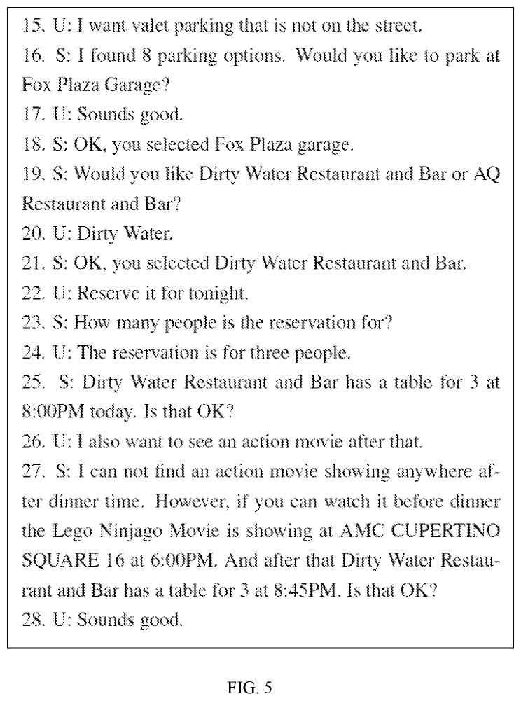

FIGS. 4 and 5 provide an example of a transcript taken from an actual dialog produced by a computerized collaborative dialog manager system in accordance with an embodiment of the invention. The scenario involves a user interacting with the system to obtain restaurant followed by parking information. Later, the user also expresses interest in watching a movie after dinner. During the dialog, the system and the user jointly refine, adopt and execute supporting intentions, and the user changes his mind several times about possible options. The three tasks interact spatially, as the user would like to secure parking as close as possible to the chosen restaurant, as well as temporally as in the case of the movie after the meal. The system, for each new user constraint, either works toward reducing the space of options remaining or processes any side effects that might result from a changed constraint. An implementation of a solution, in accordance with an embodiment of the invention, is an integrated system that processes spoken natural language utterances, followed by parsing, semantic processing, dialog processing, planning and reasoning.

In the first 5 utterances of the example of FIG. 4, the user reveals an initial set of constraints. In utterance 3, the system summarizes a few available choices, rather than listing all of them. Before settling on a choice, the user wants to check on parking in utterances 6-9, and the system must determine whether the parking is dependent on the dining task. This is signaled linguistically via anaphoric reference in utterance 6. After settling on parking, in utterance 10, the system reminds the user that a specific restaurant has not yet been chosen and in utterance 11 the user changes previous constraints involving cost and cuisine. At this point, the option space has changed as the new constraint conflicts with previous ones. However, the system assumes that other constraints regarding location still hold. This leads to new recommendations in utterance 12 and initiation of a new parking task in utterance 13 (since the previous restaurant option was revised); the exchange that follows elaborates on the new task with new constraints involving the type of parking. The anaphoric reference here is dealt with, in this example of a system in accordance with an embodiment of the invention, by choosing the last restaurant mentioned.

Utterances 14 (of the example of FIGS. 4) and 15-18 (of the example of FIG. 5) wrap up the parking subdialog, and, in lines 19-21 of FIG. 5, the restaurant is finally chosen. In utterance 22, the user requests that the system reserve a table at the chosen restaurant, and the system infers that the user is actually going to eat at the restaurant (an intention to find a restaurant is revised to an intention to eat dinner) and will incorporate any appropriate information, such as travel time, into subsequent planning. Utterances 23-25 complete addition of the necessary details, but in utterance 26, the user decides to also watch an action movie after dinner.

In this example of a system in accordance with an embodiment of the invention, it is assumed that the preposition “after” here is interpreted pragmatically as in “as soon as possible after.” Consequently, the dependency between dining and movie tasks is tied to that temporal constraint, and subsequent choices will reflect the cost in terms of travel time (that is, leading to positive or negative interactions). This triggers planning that is explained in utterance 27 involving temporal relaxation (i.e., revision) (Yu and Williams, 2013) of previous constraints to arrive at a useful recommendation, which, in this case, involves a change to watching a movie before dinner and moving dinner to a later time. Upon conclusion, the system interacts with a reservation server to make the reservation.

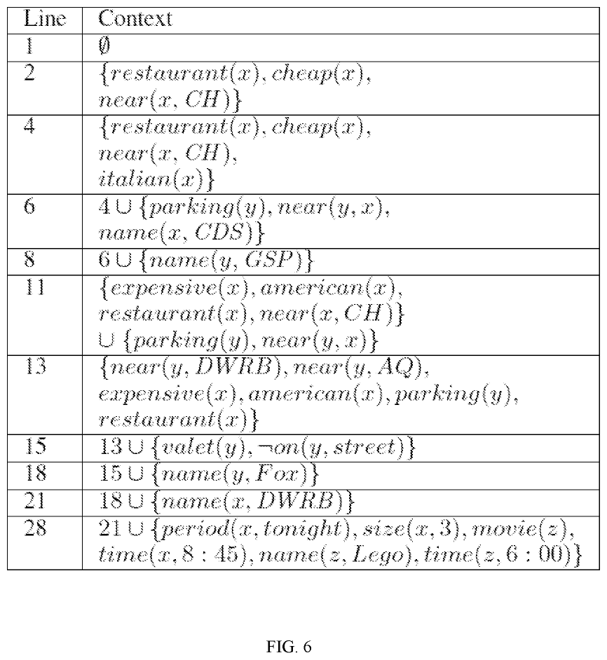

FIG. 6 is a chart summarizing changes in context during the example scripts of FIGS. 4 and 5 for use of a computerized collaborative dialog manager system in accordance with an embodiment of the invention. In FIG. 6, “CH” means “City Hall,” “DWRB” means “Dirty Water Restaurant and Bar,” “CDS” means “Café Delle Stelle,” “GSP” means “Gough Street Parking,” and “AQ” means “AQ Restaurant Bar.” The first intention begins on line 2 of the transcript of FIGS. 4 and 5, a second on line 6 of that transcript, and a third on line 26 of that transcript; the conversation alternates between these intentions.

To support multiple task dialogs using a computerized personal assistant in contexts such as those illustrated in FIGS. 4 through 6, there is provided in FIG. 1 a schematic block diagram of a computerized collaborative dialog manager system 100 for managing a dialog between a computerized personal assistant 108 and a human user 110, in accordance with an embodiment of the invention. The computerized collaborative dialog manager system 100 comprises a processor 102, and a memory 104 with computer code instructions stored thereon. The processor 102 and the memory 104, with the computer code instructions, are configured to implement a task engine 106. The task engine 106 is configured to perform dialog processing to permit the computerized personal assistant 108 to interact with the human user 110 in a collaborative dialog 116 to ascertain values of parameters 118 to execute multiple task intentions 114 (here indicated as Task Intention 1 through Task Intention N) of the human user 110 in the same collaborative dialog 116. One or more of the multiple task intentions 114 are initially partially specified—for example, to reserve a table at some restaurant. Two or more of the multiple task intentions 114 may interact with each other, in one or more task interaction 115, by which there is one or more of a greater cost or a lesser cost of performing the two or more of the multiple task intentions 114 together.

The task engine 106 includes an iterative expansion engine 120, which performs dialog processing that involves iteratively expanding 117 the multiple task intentions 114 that are included in an intention base 111. This continues until the computerized personal assistant 108 and the human user 110 collaboratively arrive at values of the parameters 118 of the multiple task intentions 114 of the intention base 111 that are executable by the computerized personal assistant 108. The task engine 106 also comprises an option engine 122 that is configured, at each iteration, to evaluate a new option to be expressed via an utterance of the computerized personal assistant 108 to the human user 110.

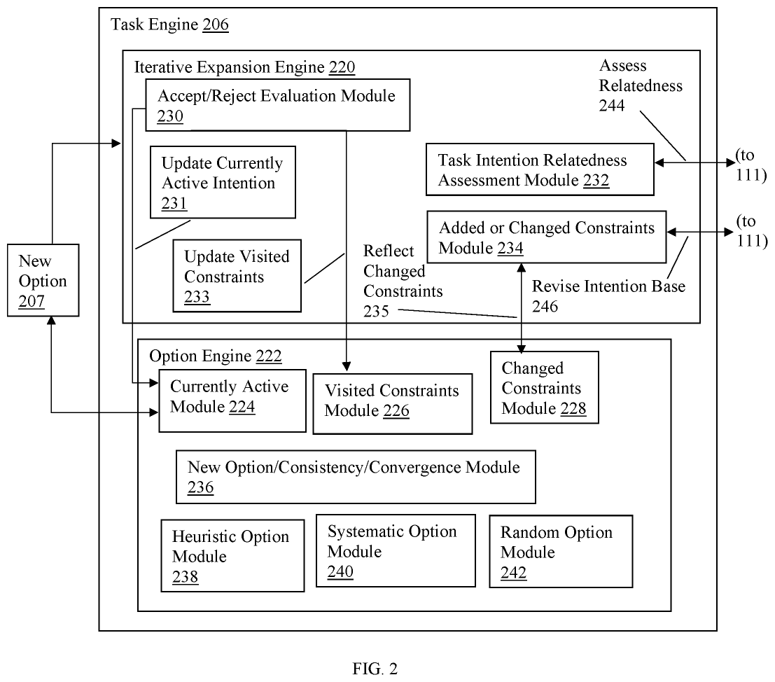

FIG. 2 is a schematic block diagram of a task engine 206 in a computerized collaborative dialog manager system, such as system 100 of FIG. 1, in accordance with an embodiment of the invention. In this embodiment, the option engine 222 includes a currently active module 224, a visited constraints module 226 and a changed constraints module 228. These modules include, for example, references to storage locations in memory 104 (see FIG. 1) for electronic data indicating a currently active task intention, in currently active module 224; any constraints for the currently active task intention that have already been considered in previous iterations, in visited constraints module 226; and any changes in the intention base 111 (see FIG. 1) that have resulted from revisions of the intention base 111 in previous iterations, in changed constraints module 228 (see FIG. 2). The option engine 222 uses components such as 224-226 to evaluate a new option 207 (which it has generated, as described herein), based on a currently active task intention stored in module 224, any constraints for the currently active task intention that have already been considered in previous iterations in module 226, and any changes in the intention base 111 that have resulted from revisions of the intention base 111 in previous iterations, in module 228. The option engine 222 is configured, at each iteration, to evaluate the new option 207 using a new option/consistency/convergence module 236, which determines a new constraint that has not been considered before, that is consistent with the intention base 111, and that reduces future options for the intention base 111. In this way, by iteratively evaluating such new options 207, the collaborative dialog converges on the intention base 111 being executable by the computerized personal assistant 108. In order to generate the new option 207, the option engine 222 can use one or more of a heuristic option module 238, which uses a heuristic to generate the new option 207 at each iteration; a systematic option module 240, which uses a systematic procedure to generate the new option 207 at each iteration; a random option module 242, which uses a random or pseudo-random procedure to generate the new option 207 at each iteration; or a module that uses another technique of generating the new option 207.

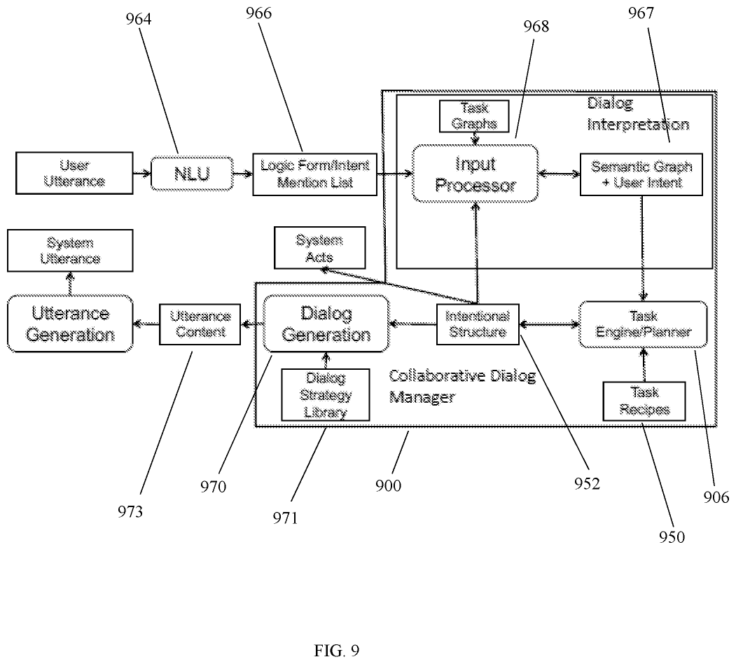

In the embodiment of FIG. 2, the task engine 206 is configured to evaluate the new option 207 by a computerized process comprising presenting the new constraint of the new option 207, for the currently active task intention, to the human user 110 (of FIG. 1). An iterative expansion engine 220 (see FIG. 2) includes an accept/reject evaluation module 230, which, if the human user accepts the new constraint, updates 231 the currently active task intention in the currently active module 224 of the option engine 222 with the new constraint, and updates 233 the constraint as having been considered, in the visited constraints module 226. If the human user rejects the new constraint, the accept/reject evaluation module 230 updates 233 the constraint as having been considered in the visited constraints module 226. The iterative expansion engine 220 also includes a task intention relatedness assessment module 232, which communicates at 244 with the intention base 111 of FIG. 1 to assess relatedness. The task intention related assessment module 232 determines whether the human user has proposed a new task intention that is related in parameters to an existing task intention of the intention base 111. If so, the task intention related assessment module 232 shares parameters between the new task intention and the existing task intention in the intention base 111. If, on the other hand, the task intention related assessment module 232 determines that the human user has proposed a new task intention unrelated to an existing task intention, the task intention related assessment module 232 augments the intention base 111 with the new task intention. Further, task intention related assessment module 232 can be configured to, upon receiving an interpreted utterance of the human user that is unrelated to performing collaborative dialog to ascertain values of parameters to execute multiple task intentions of the human user, determine the need to generate a natural language response to the human user to guide the human user to return to the collaborative dialog. This can, for example, be performed by the module 232 adjusting components of the intention base 111 (or another parameter controlled by the task engine 206), which are subsequently used for dialog generation module 970 (see FIG. 9) for generating the utterance to the user. The iterative expansion engine 220 (of FIG. 2) also includes an added or changed constraints module 234, which is in communication at 246 with the intention base 111. If the human user adds a new constraint or changes an existing constraint, the added or changed constraints module 234 revises the intention base 111 to include the new constraint or changed constraint and to change any other constraints in the intention base 111 that are affected by the new constraint or changed constraint; and reflects 235 the changed or added constraints in the changed constraints module 228 of the option engine 222.

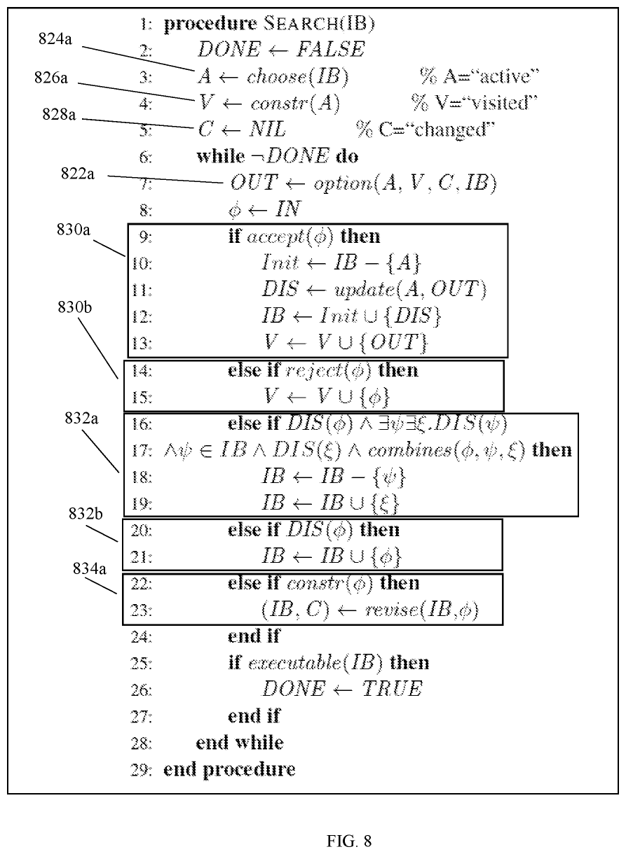

With reference to the embodiment of FIG. 8, that figure is an example of a procedure for an automated search dialog implemented by a computerized collaborative dialog manager system in accordance with an embodiment of the invention. Procedures 824a, 826a and 828a are examples of procedures used to interact with currently active module 224 (of FIG. 2), visited constraints module 226 and changed constraints module 228, respectively, as described above relative to FIG. 2. Procedure 822a (of FIG. 8) is an example of a procedure by which option engine 222 (of FIG. 2) generates a new option 207, as described above relative to FIG. 2. Procedure 830a is an example of a procedure used by accept/reject evaluation module 230 (of FIG. 2) when the human user accepts the new constraint, whereas procedure 830b is an example of a procedure used by accept/reject evaluation module 230 (of FIG. 2) when the human user rejects the new constraint, as described relative to FIG. 2. Procedure 832a is an example of a procedure used by task intention related assessment module 232 (of FIG. 2) when the human user has proposed a new task intention that is related in parameters to an existing task intention of the intention base, as described relative to FIG. 2. Procedure 832b is an example of a procedure used by task intention related assessment module 232 (of FIG. 2) when the human user has proposed a new task intention unrelated to an existing task intention, as described relative to FIG. 2. Procedure 834a is an example of a procedure used by added or changed constraints module 234 (of FIG. 2) when the human user adds a new constraint or changes an existing constraint, as described relative to FIG. 2. The procedure ends on lines 25 and 26 of the procedure of FIG. 8, when the intention base is executable by the computerized personal assistant 108.

In more detail, in the embodiment of FIG. 8, the procedure shown implements a multi-intent search dialog. The procedure is invoked with an intention base, IB, that contains a set of DIS's in the following (referred to as “canonical”) form: [symbol] Id, Vars, Act, Constraints, Sub [symbol] , where Sub is a set of ID's representing sub-task DIS's. Each sub-DIS can have sub-DIS' s, until the top-level intention is fully elaborated and executable.

The procedure of the embodiment of FIG. 8 is a loop which expands each element of IB until each is executable (lines 24-26). Multiple intentions in search dialogs are not treated as interruptions using a stack because the next step in a dialog might not necessarily involve the most recent intention that had been expanded. Instead, the procedures choose and option in lines 3 and 8, respectively, consider all of the current DIS's during each step in the loop and pick one to explore next. As the first step, some DIS is chosen (line 3) and assigned as “active” to variable A from the initial set (if the IB contains only one element then this returns that element). Then at each step, a new option for the user, expressed via a system utterance, is considered based on the currently active DIS, the constraints for that DIS considered in previous iterations (V, for “visited”), and any changes (C) in the IB that might have resulted from the revision in line 22.

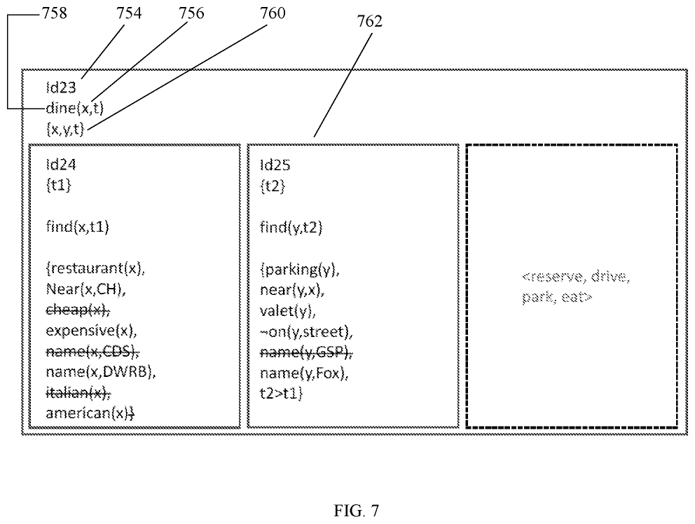

In the procedure of the embodiment of FIG. 8, the dialog begins in line 7 of FIG. 8 with an option output to the user, i.e., a new constraint for the active DIS. Constraints are stored with the id of the associated intention. The user's input from line 8 of FIG. 8 is then examined: if the user is accepting the proposal (line 9; example utterances 8 and 17 from FIGS. 4 and 5), then the system updates A with the constraint (that is, adds ϕ to the set Constraints in the canonical form mentioned above) and also the set of constraints so far visited. If the user rejects the proposal (lines 14 and 15), the set V is simply augmented. If the user instead suggests a new task (lines 16-19), such as a request for parking information in the middle of restaurant considerations, then that input is used to augment the IB. Line 16 checks if there is a way to combine the new DIS with the existing one so that variables can be shared between the two tasks (i.e., the variables in a statement such as near(x, y)). For example utterances 6-8, 13, and 26 (of FIGS. 4 and 5) lead to a DIS like the one shown in FIG. 7. If the user adds a new constraint (line 22; example utterances 4, 11 and 15) unrelated to the suggestions from the system, the system revises the IB (line 22) and returns the new IB and any changes that result. This case is the most complicated: as we noted earlier, a revision (such as found in utterance 11 of FIG. 4) can lead to multiple DIS changes or even multiple possible changes to an individual DIS. These are collected in line 22 of FIG. 8 and used during the next step in line 7 to decide which DIS to next focus on.

In the example procedure of FIG. 8, the procedure option selects a new option (constraint) that has not been considered before (hence, the inclusion of the set V), is consistent with IB, and reduces the set of future options. Since each new option is checked for consistency (as well as possibly inconsistent suggestions by the user in line 22), the procedure eventually converges to an executable IB. In default settings, there may be templates that suggest which parameters should be determined first. However, the procedure is not complete, since the user will only visit a subset of possible options that would lead to a fully fleshed-out IB. This is actually a feature of the procedure as a user would be quite unhappy if forced to consider every possible option before a final decision. In this way, the procedure adopts a satisficing approach. In an embodiment according to the invention, a separate step can, for example, be added to handle conventional interruptions using a stack.

With reference to the embodiment of FIG. 9, that figure is a schematic block diagram of components of a computerized personal assistant including a computerized collaborative dialog manager system 900 in accordance with an embodiment of the invention. In the embodiment of FIG. 9, the computerized collaborative dialog manager system 900 includes a dialog generator 970 configured to generate natural language to be uttered to the human user, for example by making use of a dialog strategy library 971 to prepare utterance content 973. The computerized collaborative dialog manager system 900 includes an input processor 968 that is configured to receive, from a natural language understanding engine 964, a natural language interpretation 966 of utterances of the human user to a speech recognition system. The natural language interpretation 966 can, for example, include at least one of: (i) intent data and mention list data from a statistical natural language system and (ii) logical form natural language data output from a deep natural language system. The task engine 906 is configured to use the natural language interpretation 966 as the basis for at least one of a new constraint and a new task intention for the collaborative dialog between the computerized personal assistant and the human user, for example by first receiving the natural language interpretation 966 via a semantic graph and user intent module 967. The task engine 906 is configured to model a task intention of the human user in a dynamic intention structure or other intentional structure 952, based at least on consulting a library of task recipes 950. The task recipes 950 specify how domain tasks are to be carried out, in a hierarchical task model.

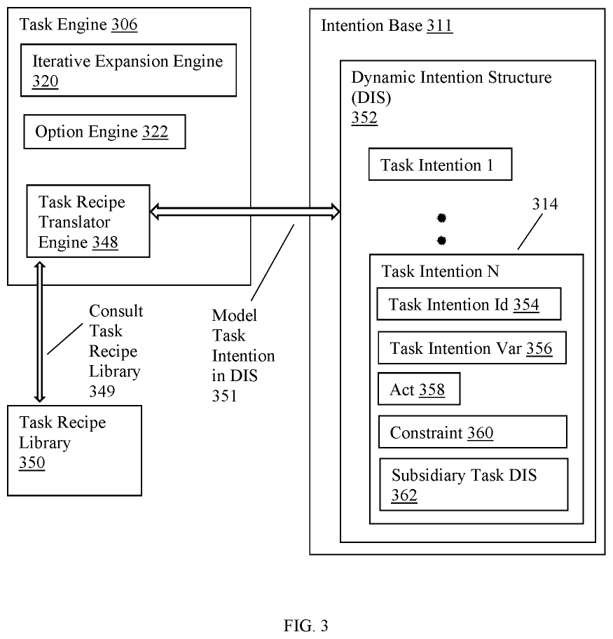

Turning to FIG. 3, that figure is a schematic block diagram of a task engine 306 interacting with an intention base 311 in a computerized collaborative dialog manager system (such as 100, 900 or another system taught herein), in accordance with an embodiment of the invention. The iterative expansion engine 320 and option engine 322 each interact with the intention base 311, and each other, as taught herein. In addition, the intention base 311 of FIG. 3 includes a dynamic intention structure 352 implemented by the task engine 306. This includes, for example, for each task intention 314: a task intention identifier 354, a task intention variable 356, an act 358, a constraint 360, and a representation 362 of any subsidiary task dynamic intention structure. The task engine 306 includes a task recipe translator engine 348, which consults 349 the task recipe library 350 to model 351 a task intention of the human user in the dynamic intention structure 352. For example, by consulting the hierarchical task model of the task recipe library 350, the task recipe translator engine 348 can establish which tasks are indicated as subsidiary tasks for a task intention 314 using the representation 362 of the subsidiary task dynamic intention structure.

Turning to FIG. 7, that figure is a schematic block diagram of a dynamic intention structure used in a computerized collaborative dialog manager system, in accordance with an embodiment of the invention. This embodiment indicates in schematic form an example of a task intention that includes representations 762 of subsidiary intentions. Here, the identifier 754 of this task intention is “Id23,” associated with the act “dine (x,t)” for task intention variables 756 “x” and “t.” The constraints 760 are “{x, y, t}.” The subsidiary task intentions are indicated in boxes 762, with identifiers “Id24” and “Id25,” and each include their own identifiers, variables, acts and constraints, and could, in turn, include their own representations of subsidiary task dynamic intention structures. In a search dialog, an agent normally first intends an action at a high level, such as “intending to have dinner tonight” which is then elaborated with details regarding the restaurant, location, time, etc. An embodiment according to the invention models an agent's intentions using Dynamic Intention Structures (DIS) (Ortiz and Hunsberger, 2013), such as that shown in FIG. 7, as it was developed to support incremental intention elaboration. DIS's range over act types. Incompleteness of an intention can be captured in one of three ways: (1) through existential quantifiers within the scope of the intention (for example, intends(User, ∃x.reserve(x)∧A restaurant(x)∧A italian(x)) in which no commitment has yet been made on the value for x; (2) incompletely specified constraints for the intended action (in the formula just given the reservation time has not yet been decided upon); and (3) action descriptions that have not yet been fully decomposed (for example, one might wish to reserve a restaurant by going to a reservation server). The theory of DIS's draws from ideas in Discourse Representation Theory (DRT) (Kamp and Reyle, 1993), used in a new manner in an embodiment according to the invention. As in DRT, DIS's incorporate the “box notation”, modified in accordance with an embodiment of the invention to represent intentions and their structure. FIG. 7 illustrates the box notation that captures the content of the user's intention as modeled by the system after utterance 21 (of FIG. 5). As shown in FIG. 7, each DIS has local variables that are shared between tasks and represent shared resources and constraints associated with an action. Hierarchical action structure is captured via sub-boxes. The representation shown in FIG. 7 is a simplification as it does not capture the system intentions during the collaboration: they are left implicit although discussed elsewhere herein. Augmentations of the DIS can capture a Group Activity Related Intention (GAR) (Grosz and Hunsberger, 2006) by specifying the agents and other elements. A further simplification is that one should read the boxes as under the scope of an “intends” modality.

In FIG. 7, in accordance with an embodiment of the invention, variables are all existentially quantified in the first-order logic (FOL) translation (semantics) so that the box shown is shorthand for intends(∃x∃y∃t.dine(x, t) . . . ). Each intention has an Id 754, an act 758 type (e.g., find(x, t)), a set of constraints 760, and a set of subsidiary intentions 762 with their own local variables. The variables x and t, for example, under Id23, 754, are shared among the sub-intentions 762. In FIG. 7, the related reserve, drive to, and eat intentions in the right-most box have not yet been specified; and constraints that are crossed out are ones that were revised previously with new choices.

In accordance with an embodiment of the invention, a collection of intentions is modeled in an Intention Base (IB). When an agent changes his mind about a constraint revision occurs. The revision of an IB involves a number of steps (Ortiz and Hunsberger, 2013). What follows is an example focusing on revision of constraints with respect to cases (1) and (2) above regarding incomplete intentions. Let C_{I} be some set of constraints associated with a DIS, I, in an IB. If one wants to revise C_{I} (written C_{I}*p) with some p, one collects all the maximal subsets of C_{I} that do not entail ¬p: C_{I}*p={S∪{p}|S⊆C_{I}, S [symbol] ¬p, if S⊂T⊆C_{I} then T [symbol] ⊆p}. Suppose ψ∉C_{I} but C_{I} [symbol] ψ, then one calls ψ the “side effect” of the initial IB. With this definition of revision, side effects can be removed automatically. Suppose that: C_{I}={italian(x), restaurant(x), name(x, CDS), name(x, CDS)⊃D restaurant(x)∧italian(x)∧cheap(x)} and one has the background knowledge, italian(p)⊃¬american(p). If one intends to go to restaurant CDS and one later decides to go to an American restaurant one will no longer intend to go to CDS. Here, it is noted that there is not always a unique revision but in this example, for the sake of simplicity, it is assumed that there is. In addition, it is noted that one can think of the variable x appearing in non-rules (e.g., italian(x)) as really a skolem constant. As mentioned herein, the semantics of the boxes is in terms of a translation into formulas involving a leading “intends” modality with the implicit existentials for variables in the boxes made explicit. During the revision, boxes are unpacked into components, like the constraints shown here, revised and checked for consistency in terms of the modal logic translation and then reconstructed into new boxes. The example rules shown are usually “protected,” in an implemented embodiment, and not subject to revision.

An embodiment according to the invention implements a conversational assistant prototype system called the Intelligent Concierge. The system converses with the user about common destinations such as restaurants, movie theaters, and parking options. It helps users refine their needs and desires until they find exactly what they are happy with. A Natural Language Understanding (NLU) pipeline provides input to the Collaborative Dialog Manager (CDM), that operates at the center of the Concierge, taking a user utterance in the form of natural language text produced by a speech recognition system and interpreting it. The NLU's output can be either an intent and mention list from a statistical NL system (Wang et al., 2011) or a logical form that is output from a deep NLU system (Dahlgren, 2013), which is focused on in the following discussion. With the aid of a library of reasoning components and backend knowledge sources, CDM interprets input in the context of the current dialog and evolving intention and processes dialogs of the form seen herein, taking the user's request, performing required actions such as making a restaurant reservation, requesting more information such as preferences regarding a particular cuisine, or offering information to the user such as providing a list of restaurant options. External sources, such as Opentable, are accessed via backend reasoning processes. The operation of CDM and support for search dialogs is assisted by tightly integrating the dialog manager with supporting reasoning modules: the latter informs the dialog manager as to what to say next, how to interpret new user input, or how to revise an intention. A temporal relaxation planner can be incorporated for reasoning about domain actions that produces the output associated with utterance 27, for example. Finally a Natural Language Generation (NLG) component generates the natural language surface form of the system output if CDM decides on a conversational action.

In accordance with an embodiment of the invention, CDM is built on top of a Dialog development framework (Rich and Sidner, 2012) based on Collaborative Discourse Theory (Grosz and Sidner, 1990; Grosz and Kraus, 1996; Lochbaum, 1998; Sidner, 1994). In the framework of an embodiment according to the invention, dialog participants have their own desires, beliefs, and intentions, but they may be inconsistent with each other. Dialog is the process in which the participants communicate and get them to be consistent in relevant ways.

The purpose of a dialog is to form a full plan between the user and the system in order to achieve a joint goal (i.e., an elaborated IB). Utterances of the other participant are processed and internalized to augment the agent's view of their collaboration.

The embodiment of FIG. 9, discussed above, illustrates the dialog reasoning process of CDM. A model of user beliefs in the system is first mapped from the logical form produced by the NLU:

imp (Ex5 Ex1: (restaurant (x1) & _cardy (x1,_p1) & Ex2: (cheap (x2) & _mod (x1,x2)) & Ex6 Ex7 Ex3: (City-Hall (x3) & Ex8 Ex9 Ex4: (San-Francisco (x4) & in4(x3,x4) & ) _location (x3,x4)) & near (x1,x3) & _location (x1,x3)) & find(_inf,_e1) & _obj (_e1,x1) & _subj (_e1,_you)))

and maintained in a layered semantic graph form. Intentions are represented as DIS's.

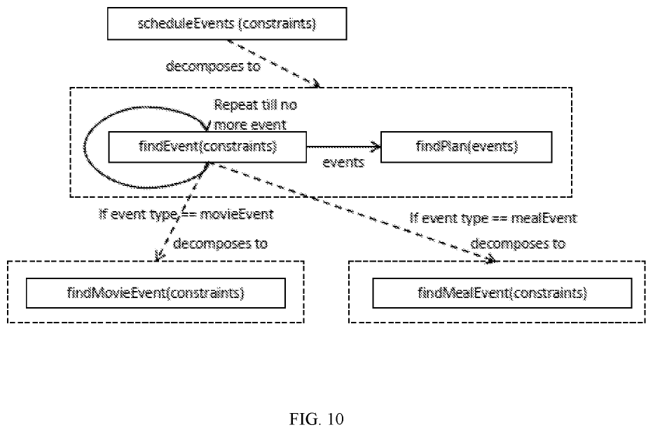

Unlike most other modern dialog systems, CDM, in an embodiment according to the invention, does not make use of a finite state machine (Pieraccini and Huerta, 2005) or information states (Larsson and Traum, 2000) to model the dialog state. Instead, it builds DIS's using a library of task recipes, each of which specify how domain tasks should be carried out or composed. Tasks can be both physical tasks (e.g., driving) as well as internal (“mental”) actions (e.g., scheduling). Each recipe, as, for example, shown in FIG. 10, is written using a hierarchical task modeling language ANSI/CEA-2018 (Rich and Sidner, 2012), whose built-in rich task relations and ability to capture common planning features such as task inputs, outputs and pre/post-conditions, allows CDM to employ planning techniques to form a joint action plan and realize a joint goal.

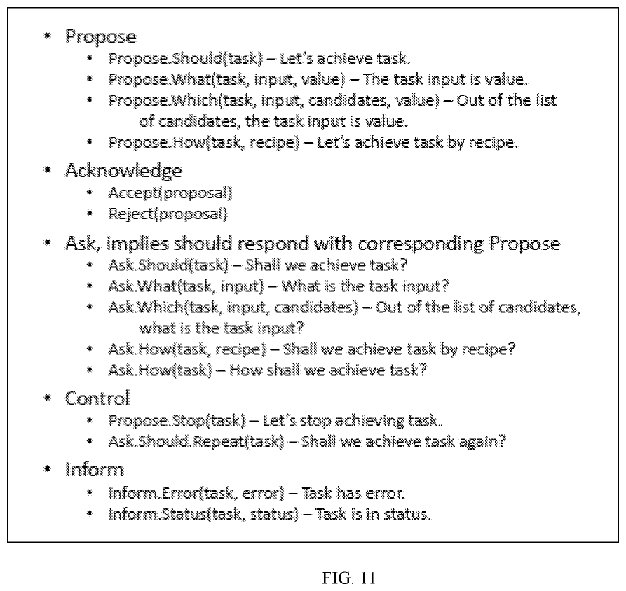

In accordance with an embodiment of the invention, actions are generated when the system cannot form a full plan from its recipe library and the user needs to be consulted to gain additional information. CDM has a library of basic utterance types, shown, for example, in FIG. 11, and corresponding generation rules for dialog interpretation and generation. For example, if there are multiple possible values for a task's input, an Ask.Which system utterance can be generated to request the user to choose among them. For most tasks, one only needs to add a task recipe; there is no need to hand-author dialog trees. Dialog reasoning, interpretation, and generation are separate from domain task reasoning. Recipes capture how domain tasks should be achieved while the dialog manager reasons about what utterances are needed to facilitate collaboration. This allows planning techniques to be more easily used on domain action planning and plan recognition without worrying about dialog actions and minimizes the need to hand-author extensive dialog trees for every possible dialog scenario.

To provide an example of the operation of CDM, in accordance with an embodiment of the invention, there follows an example description of the dialog interpretation process which maps NLU output into an utterance type in the dialog context. When the user asks to “Find cheap restaurants near San Francisco City Hall” as the opening request in the sample dialog in FIGS. 4 and 5, CDM interprets it as Propose.Should(findRestaurant(x)) with value(x)=“cheap”, and location(x)=“near San Francisco City Hall”. These are program statements that mirror the logical notation used in the DIS boxes earlier. As the dialog progresses, dialog interpretation becomes more complicated, especially in the case of mixed initiative user responses.

In accordance with an embodiment of the invention, a procedure ranks potential interpretations, first assuming that each user utterance represents the beginning of a new dialog. Then, preferring to carry on with an existing subdialog, CDM identifies any potential interpretations that would fit into the current dialog context, and re-rank or change the interpretation if necessary (step 21 in FIG. 8). As an example, when the user asked “How about Italian” (utterance 4) in the sample dialog, CDM initially interprets it as Propose.Should(findRestaurant(x), cuisine(x)=“Italian”. However, after putting the interpretation in context, it modifies the interpretation to Propose. What(findRestaurant(x), cuisine(x)=“Italian”), where the findRestaurant refers to the existing intention generated for utterance 2 instead of a new one.

Sometimes, the interpreted task is consistent with the dialog context, but not all of the specific task input values (lines 22-23 of FIG. 8). When this happens, CDM invokes its consistency checking procedure to minimally change existing constraints. For example, when the user requests “an upscale American restaurant” (utterance 11), CDM decides that even though the currently active intention is the same findRestaurant(x) task as before, the previous stated preferences for value(x)=“cheap” and cuisine(x)=“Italian” need to be revised to value(x)=“expensive” and cuisine(x)=“American”. (In this example, “upscale” is equated with “expensive” by the system).

There are times when the user is legitimately changing topics in the middle of a conversation, such as when the user asks to “Find parking near there” (utterance 6) after the system suggested Caffe Delle Stelle. The current dialog context suggests that the interpreted user utterance remain Propose.Should(findParking(y)). However, this does not mean that the two sub-dialogs are unrelated. In fact, linguistic cues such as the anaphoric expression “there” clearly signals the interdependency between the two tasks (lines 16-19 in FIG. 8). CDM then transfers control from the findRestaurant intention and starts elaboration of the new intention findParking, and at the same time records their interdependency.

A slightly more complicated intention interdependency occurs in the sample dialog when the user asks to “see an action movie” (utterance 26) after going to the restaurant. Initially, CDM interprets the user request as Propose.Should(findMovie(z)). However, while trying to reconcile it with the existing task findRestaurant(x), CDM discovers that the two tasks should not be executed separately (this could result in a negative interaction, i.e., higher cost), but instead be composed into a single supertask scheduleEvents (see FIG. 8, line 16). As a result, the user utterance is reinterpreted as Propose.Should(scheduleEvents(e)). The old task findRestaurant is then combined with task scheduleEvents and becomes active.

In summary, an embodiment according to the invention provides support for multi-intent search dialogs, in which a user and a VPA incrementally exchange information to support achievement of some set of user tasks. These tasks can interact and choices made by the user can be revised during the course of the dialog. Those revisions can, in turn, lead to modifications in the ongoing specification of other tasks. The approach is a plan-based one in which a dialog between two agents is viewed as a collaboration involving the tasks under discussion. An embodiment according to the invention exhibits robustness in the range of dialogs that can be supported through richness of task models, task elaboration strategies and dynamic revisions, and can closely integrate dialog processing and supporting reasoning.

In an embodiment according to the invention, processes described as being implemented by one processor may be implemented by component processors configured to perform the described processes. Such component processors may be implemented on a single machine, on multiple different machines, in a distributed fashion in a network, or as program module components implemented on any of the foregoing. In addition, systems such as computerized personal assistant 108, computerized collaborative dialog manager system 100, 900, and their components, can likewise be implemented on a single machine, on multiple different machines, in a distributed fashion in a network, or as program module components implemented on any of the foregoing. In addition, such components can be implemented on a variety of different possible devices. For example, computerized personal assistant 108, computerized collaborative dialog manager system 100, 900, and their components, can be implemented on devices such as mobile phones, desktop computers, Internet of Things (IoT) enabled appliances, networks, cloud-based servers, or any other suitable device, or as one or more components distributed amongst one or more such devices. In addition, devices and components of them can, for example, be distributed about a network or other distributed arrangement.

Although embodiments are described herein with reference to “utterances” of a computerized personal assistant, including by generating natural language utterances, it should be understood that a variety of different possible ways of interacting with a human user can be implemented in accordance with an embodiment of the invention. For example, depending on the technical context and desired user experience, one or more computerized components of a system can generate, and communicate using, “utterances” that include one or more of: computer-generated natural language speech utterances, computer-generated text messages, computer-generated graphical displays, computer-generated color indicators, computer-generated tactile messages for the visually impaired, and a variety of other possible computer-generated utterances. Similarly, although embodiments are described herein that include a computerized system performing natural language understanding in order to process a human user's actions or decisions (such as accepting constraints, rejecting constraints, and proposing new task intentions), it should be appreciated that the human user's interaction with the computerized system can be in a variety of different possible forms. For example, one or more computerized components of a system can receive a human user's utterances in the form of: natural language speech, text messages, interactions with a graphical display by gesture or tactile contact with the display, buttons and other devices, or a variety of other possible computer input techniques.

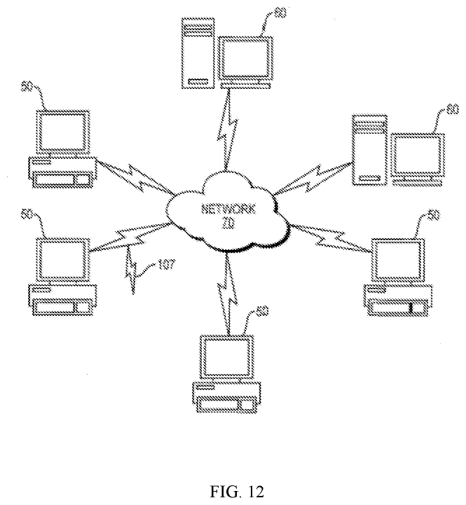

FIG. 12 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

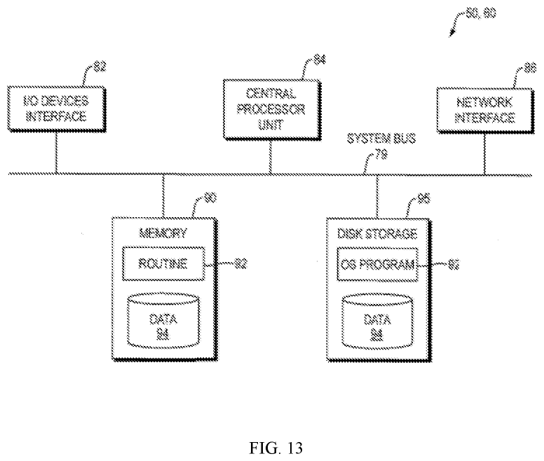

FIG. 13 is a diagram of an example internal structure of a computer (e.g., client processor/device 50 or server computers 60) in the computer system of FIG. 12. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 12). Memory 90 provides volatile storage for computer software instructions 92 and data 94 used to implement an embodiment of the present invention (e.g., task engine 106, 206, 306, iterative expansion engine 120, 220, 320, accept/reject evaluation module 230, task intention related assessment module 232, added or changed constraints module 234, option engine 122, 222, 322, currently active module 224, visited constraints module 226, changed constraints module 228, new option/consistency/convergence module 236, heuristic option module 238, systematic option module 240, random option module 242, intention base 111, 311, task recipe translator engine 348, task recipe library 350, dynamic intention structure 352, the components and modules of the embodiment of FIG. 9, detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92. In alternative embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

### REFERENCES

P. A. Crook, A. Marin, V. Agarwal, K. Aggarwal, T. Anastasakos, R. Bikkula, D. Boies, A. Celikyilmax, S. Chandramohan, Z. Feizollahi, R. Holenstein, J. Jeoong, O. Z. Khan, Y. B. Kim, E. Krawczyk, X. Liu, D. Panic, V. Radostev, N. Ramesh, J. P. Robichaud, A. Rochett, L. Sronberg, and R. Sarikaya. 2015. Task completion platform: A self-serve multi-domain goal oriented dialogue platform. In NIPS-SLU15.

Kathleen Dahlgren. 2013. Formal linguistic semantics and dialogue. In Annual Semantic Technology Conference.

David Griol and Jose Manuel Molina. 2016. A proposal to manage multi-task dialogs in conversational interfaces. Advances in Distributed Computing and Artificial Intelligence Journal, 5(2):53-65.

Barbara J. Grosz and Luke Hunsberger. 2006. The dynamics of intentions in collaborative intentionality. Cognition, Joint Action and Collective Intentionality, Special Issue, Cognitive Systems Research, 7(2-3):259-272.

Barbara J. Grosz and Sarit Kraus. 1996. Collaborative plans for complex group action. Artificial Intelligence, 86(1):269-357.

Barbara Grosz and Candace Sidner. 1990. Plans for discourse. In P. Cohen, J. Morgan, and M. Pollack, editors, Intentions in Communication, pages 417-444. Bradford Books/MIT Press, Cambridge, Mass.

Hans Kamp and Uwe Reyle. 1993. From Discourse to Logic: Introduction to Model-theoretic Semantics of Natural Language, Formal Logic, and Discourse Representation Theory. Kluwer Academic Publishers, Dordrecht, the Netherlands.

S. Larsson and D. R. Traum. 2000. Information state and dialogue management in the trindi dialogue move engine toolkit. Natural language engineering, 6(3&4):323-340.

Oliver Lemon, Alexander Gruenstein, Alxis Battle, and Stanley Peters. 2002. Multi-tasking and collaborative activities in dialogue systems. In Proceedings of the Third SIGdial Workshop on Discourse and Dialogue, pages 113-124. Karen E. Lochbaum. 1998. A collaborative planning model of intentional structure. Computational Linguistics, 34(4):525-572.

Yub-Nun Chen Ming Sum and Alexander I. Rudnicky. 2015. Understanding users cross-domain intentions in spoken dialog systems. In NIPS.

Charles Ortiz and Luke Hunsberger. 2013. On the revision of dynamic intention structures. In Proceedings of the Eleventh International Symposium on Logical Formalizations of Commonsense Reasoning.

Charles Ortiz and haying Shen. 2014. Dynamic intention structures for dialogue processing. In Proceedings of the 18th Workshop on the Semantics and Pragmatics of Dialogue (SemDial 2014).

R. Pieraccini and J. Huerta. 2005. Where do we go from here? research and commercial spoken dialog systems. In 6th SIGdial Workshop on Discourse and Dialogue.

Charles Rich and Candace L. Sidner. 2012. Using collaborative discourse theory to partially automated dialogue tree authoring. In 14th International Conference on Intelligent Virtual Agents, September.

A. Rudnicky and X. Wei. 1999. An agenda-based dialog management architecture for spoken language systems. In IEEE ASRU, Seattle, Wash.

Candace L. Sidner. 1994. An artificial discourse language for collaborative negotiation. In Proceedings of AAAI, pages 814-819.

Ye-Yi Wang, Li Deng, and Alex Acero. 2011. Semantic Frame Based Spoken Language Understanding. Wiley, January.

Fan Yang, Peter A. Heeman, and Andrew L. Kun. 2011. An investigation of interruptions and resumptions in multi-tasking dialogues. Association for Computational Linguistics, 37(51):75-104.

Peng Yu and Brian Williams. 2013. Continuously relaxing over-constrained conditional temporal problems through generalized conflict learning and resolution. In Proceedings of the Twenty-third International Joint Conference on Artificial Intelligence (IJCAI-2013).

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method for managing a dialog between a computerized personal assistant and a human user, the computer-implemented method comprising:
performing dialog processing to permit the computerized personal assistant to interact with the human user in a collaborative dialog to ascertain values of parameters to execute multiple task intentions of the human user in the same collaborative dialog, at least one of the multiple task intentions being initially partially specified,
the dialog processing comprising, with a task engine of the computerized personal assistant, iteratively expanding task intentions of an intention base comprising the multiple task intentions until the computerized personal assistant and the human user collaboratively arrive at values of the parameters of the multiple task intentions of the intention base that are executable by the computerized personal assistant; and
the iteratively expanding task intentions of the intention base comprising, at each iteration, using the task engine of the computerized personal assistant in evaluating a new option to be expressed via an utterance of the computerized personal assistant to the human user, the new option comprising a new constraint that has not been considered before, that is consistent with the intention base, and that reduces future options for the intention base, the collaborative dialog thereby converging on the intention base being executable by the computerized personal assistant.

2. The computer-implemented method of claim 1, wherein evaluating the new option is based on a currently active task intention, any constraints for the currently active task intention that have already been considered in previous iterations, and any changes in the intention base that have resulted from revisions of the intention base in previous iterations.

3. The computer-implemented method of claim 2, wherein evaluating the new option comprises presenting the new constraint, for the currently active task intention, to the human user, and, (i) if the human user accepts the new constraint, updating the currently active task intention with the new constraint and updating the constraint as having been considered, (ii) if the human user rejects the new constraint, updating the constraint as having been considered, (iii) if the human user proposes a new task intention that is related in parameters to an existing task intention of the intention base, sharing parameters between the new task intention and the existing task intention in the intention base, (iv) if the human user proposes a new task intention unrelated to an existing task intention, augmenting the intention base with the new task intention, and (v) if the human user adds a new constraint or changes an existing constraint, revising the intention base to include the new constraint or changed constraint and to change any other constraints in the intention base that are affected by the new constraint or changed constraint.

4. The computer-implemented method of claim 3, further comprising generating natural language to be uttered to the human user.

5. The computer-implemented method of claim 1, wherein at least two of the multiple task intentions interact with each other by one or more of a greater cost or a lesser cost of performing the at least two of the multiple task intentions together.

6. The computer-implemented method of claim 1, further comprising receiving, from a natural language understanding engine, a natural language interpretation of utterances of the human user to a speech recognition system, the natural language interpretation comprising at least one of: (i) intent data and mention list data from a statistical natural language system and (ii) logical form natural language data output from a deep natural language system; and
using the natural language interpretation as the basis for at least one of a new constraint and a new task intention for the collaborative dialog between the computerized personal assistant and the human user.

7. The computer-implemented method of claim 1, further comprising modeling a task intention of the human user in a dynamic intention structure built using a library of task recipes specifying how domain tasks are to be carried out in a hierarchical task model.

8. The computer-implemented method of claim 7, wherein the dynamic intention structure comprises, for each task intention: a task intention identifier, a task intention variable, an act, a constraint, and a representation of any subsidiary task dynamic intention structure.

9. The computer-implemented method of claim 1, further comprising modeling the at least one of the multiple task intentions, which is initially partially specified, using at least one of: (i) an existential quantifier within a scope of the initially partially specified task intention; (ii) an incompletely specified constraint of an intended action of the initially partially specified task intention; and (iii) an action description, which is not yet fully decomposed, of the initially partially specified task intention.

10. The computer-implemented method of claim 1, further comprising, upon receiving an interpreted utterance of the human user that is unrelated to performing collaborative dialog to ascertain values of parameters to execute multiple task intentions of the human user, generating a natural language response to the human user to guide the human user to return to the collaborative dialog.

11. A computerized collaborative dialog manager system for managing a dialog between a computerized personal assistant and a human user, the computerized collaborative dialog manager system comprising:
a processor; and
a memory with computer code instructions stored thereon, the processor and the memory, with the computer code instructions, being configured to implement:
a task engine configured to perform dialog processing to permit the computerized personal assistant to interact with the human user in a collaborative dialog to ascertain values of parameters to execute multiple task intentions of the human user in the same collaborative dialog, at least one of the multiple task intentions being initially partially specified, the dialog processing comprising iteratively expanding task intentions of an intention base comprising the multiple task intentions until the computerized personal assistant and the human user collaboratively arrive at values of the parameters of the multiple task intentions of the intention base that are executable by the computerized personal assistant; and
the task engine comprising an option engine configured to, at each iteration, evaluate a new option to be expressed via an utterance of the computerized personal assistant to the human user, the new option comprising a new constraint that has not been considered before, that is consistent with the intention base, and that reduces future options for the intention base, the collaborative dialog thereby converging on the intention base being executable by the computerized personal assistant.

12. The computerized collaborative dialog manager system of claim 11, wherein the task engine is configured to evaluate the new option based on a currently active task intention, any constraints for the currently active task intention that have already been considered in previous iterations, and any changes in the intention base that have resulted from revisions of the intention base in previous iterations.

13. The computerized collaborative dialog manager system of claim 12, wherein the task engine is configured to evaluate the new option by a computerized process comprising presenting the new constraint, for the currently active task intention, to the human user, and, (i) if the human user accepts the new constraint, updating the currently active task intention with the new constraint and updating the constraint as having been considered, (ii) if the human user rejects the new constraint, updating the constraint as having been considered, (iii) if the human user proposes a new task intention that is related in parameters to an existing task intention of the intention base, sharing parameters between the new task intention and the existing task intention in the intention base, (iv) if the human user proposes a new task intention unrelated to an existing task intention, augmenting the intention base with the new task intention, and (v) if the human user adds a new constraint or changes an existing constraint, revising the intention base to include the new constraint or changed constraint and to change any other constraints in the intention base that are affected by the new constraint or changed constraint.

14. The computerized collaborative dialog manager system of claim 13, further comprising a dialog generator configured to generate natural language to be uttered to the human user.

15. The computerized collaborative dialog manager system of claim 11, wherein the task engine is configured to manage dialog in which at least two of the multiple task intentions interact with each other by one or more of a greater cost or a lesser cost of performing the at least two of the multiple task intentions together.

16. The computerized collaborative dialog manager system of claim 11, further comprising an input processor configured to receive, from a natural language understanding engine, a natural language interpretation of utterances of the human user to a speech recognition system, the natural language interpretation comprising at least one of: (i) intent data and mention list data from a statistical natural language system and (ii) logical form natural language data output from a deep natural language system; and
the task engine being configured to use the natural language interpretation, as the basis for at least one of a new constraint and a new task intention for the collaborative dialog between the computerized personal assistant and the human user.

17. The computerized collaborative dialog manager system of claim 11, wherein the task engine is configured to model a task intention of the human user in a dynamic intention structure based at least on consulting a library of task recipes specifying how domain tasks are to be carried out in a hierarchical task model.

18. The computerized collaborative dialog manager system of claim 17, wherein the dynamic intention structure implemented by the task engine comprises, for each task intention: a task intention identifier, a task intention variable, an act, a constraint, and a representation of any subsidiary task dynamic intention structure.

19. The computerized collaborative dialog manager system of claim 11, wherein the task engine is further configured to, upon receiving an interpreted utterance of the human user that is unrelated to performing collaborative dialog to ascertain values of parameters to execute multiple task intentions of the human user, generate a natural language response to the human user to guide the human user to return to the collaborative dialog.

20. A non-transitory computer-readable medium configured to store instructions for managing a dialog between a computerized personal assistant and a human user, the instructions, when loaded and executed by a processor, cause the processor to manage the dialog by:
performing dialog processing to permit the computerized personal assistant to interact with the human user in a collaborative dialog to ascertain values of parameters to execute multiple task intentions of the human user in the same collaborative dialog, at least one of the multiple task intentions being initially partially specified,
the dialog processing comprising, with a task engine of the computerized personal assistant, iteratively expanding task intentions of an intention base comprising the multiple task intentions until the computerized personal assistant and the human user collaboratively arrive at values of the parameters of the multiple task intentions of the intention base that are executable by the computerized personal assistant; and
the iteratively expanding task intentions of the intention base comprising, at each iteration, using the task engine of the computerized personal assistant to evaluate a new option to be expressed via an utterance of the computerized personal assistant to the human user, the new option comprising a new constraint that has not been considered before, that is consistent with the intention base, and that reduces future options for the intention base, the collaborative dialog thereby converging on the intention base being executable by the computerized personal assistant.
